(19) United States
(12) Patent Application Publication
(10) Pub. No.: US 2011/0259761 A1
(43) Pub. Date: Oct. 27, 2011

(54) Precipitation of hardness salt in flow back and produced water

(76) Inventors: Dennis McGuire, Stuart, FL (US); Sanjeev Jakhete, Stuart, FL (US)

(21) Appl. No.: 12/765,998

(22) Filed: Apr. 23, 2010

(51) Int. Cl. C02F 9/06; C02F 1/461

(52) U.S. Cl. 205/755; 204/232

(57) ABSTRACT

An apparatus and method for reducing the scaling tendency of fracture-treatment flow back water and oil field brine by the precipitation of hardness salts using carbon dioxide as a carbonate donor. The apparatus includes a treatment conduit comprised of a plurality of segments. The treatment conduit includes a plurality of anode surfaces, a plurality of heated cathode surfaces each associated with an ultrasonic transducer and an arrangement for injecting carbon dioxide into the stream of raw water. The injection of carbon dioxide from an external source helps to reduce the pH of the water and to prevent scaling by softening the water thereby eliminating the use of HCL at the frac job site. The treatment conduit further includes a plurality of static mixers each creating hydrodynamic cavitation thereby facilitating better mixing of the carbon dioxide and higher mass transfer efficiency.

### FIELD OF THE INVENTION

The invention relates to a method and apparatus for the precipitation of hardness salts in flow back and produced water thereby reducing scaling tendencies.

### BACKGROUND OF THE INVENTION

The invention is related to the pre-treatment of flow back or produced water for the hydraulic fracture treatment of a subterranean formation in a well bore. The water or brine is softened by precipitating hardness salts with electrochemical cells and carbon dioxide gas.

Water is a scarce natural resource around the country. Significant oil and gas development has been curtailed due to the lack of water resources for drilling and oil field development and completion. This scarcity of water supply has resulted in the necessity for design and construction of large ponds to store surface water for oil and gas filed operations thereby increasing the amount of time and money needed for well completion. To mitigate the need for large quantities of water recycling techniques have been developed. With the development of water recycling technologies, oil and gas production companies can recycle the produced and flow back water from their hydro-fracturing operations.

The recycling of produced or flowback water has presented the oil and gas industry with a new set of problems as compared to using potable municipal water. The hardness salts present in recycled water is one of the main challenges which must be overcome when recycling flowback or produced water. These hardness salts can form a scale in the shale formations resulting in the blockage of micro pores thereby resulting in a reduction of potential gas production. A typical method for treating recycled flowback water involves the addition of a mixture of scale inhibiting chemicals to the produced water. The mixture in turn binds the scale causing salts. However, the scale inhibiting chemicals are not only expensive but they also pose a major environmental risk and may plate out on the clay particles in the formation.

### DESCRIPTION OF THE PRIOR ART

The prior art has taken various approaches in softening brine using many varied techniques. One of the first oil field brine softening methods was thermal precipitation of divalent ions with an excess of alkalinity for steam production used in oil recovery operations. U.S. Pat. No. 4,518,505 discloses steam as the heat transfers agent while U.S. Pat. No. 3,731,801 uses hot oil as the heat transfer agent

U.S. Pat. No. 4,444,675 discloses a brine softening method including the step of adding enough soda ash to increase the brine pH to 10.8 11.5 and using seed crystals of calcium carbonate to improve the magnesium hydroxide precipitation. When the brine is heated, it is called “hot lime softening” as shown in U.S. Pat. No. 4,247,371 which is directed to multi-stage flash distillation of brine to fresh water and near saturated brine soluble salts.

U.S. Pat. No. 4,444,675 discloses the use of a chemical anti-scaling agent to tie up divalent ions and carbon dioxide gas injection to lower the pH in the concentrated brine to prevent scaling and fouling heat exchanger surfaces. U.S. Pat. No. 4,472,283 also discloses the concept of injecting carbon dioxide gas to lower the pH in heated brines by adding a quaternary ammonium surfactant to the brine to keep the carbon dioxide in solution at higher temperatures.

U.S. Pat. No. 4,880,057 discloses the use of a reverse osmosis membrane to remove dissolved solids from well water and adding carbon dioxide gas to make carbonic acid. The acidic softened fresh water is then injected back into the well to remove calcium carbonate buildup around the well bore. U.S. Pat. No. 6,096,221 uses the injection of ozone and carbon dioxide into the city water source pipe to remove bio-film and calcium carbonate scale build up in the water piping for hospitals.

U.S. Pat. No. 3,425,925 discloses a galvanic electro-chemical cell that uses magnesium metal as a consumable anode to generate a colloidal suspension of seed crystals of magnesium hydroxide to prevent hard scaling in boiler tubes. The magnesium hydroxide will slightly increase the pH of the brine to encourage precipitation of calcium carbonate on the seed crystal. Copper metal is used for the cathode surface and completes the galvanic circuit. U.S. Pat. No. 4,789,448 discloses a galvanic electro-chemical sell that includes a zinc anode to generate a colloidal suspension of seed crystals. U.S. Pat. No. 4,749,457 also discloses a galvanic electro-chemical sell that includes an aluminum anode to generate a flocculating agent for colloidal suspensions. In this instance dissolved oxygen is used to enhance the corrosion rate of the aluminum anode.

U.S. Pat. No. 3,944,478 discloses a self cleaning electro-chemical cell that has an anode formed from either aluminum or iron that will generate a flocculating agent for colloidal suspension of dye. A very thin gap between the anode and cathode is used to reduce the ohmic voltage drop in the water, increase the wear rate on the aluminum anode, scour scale build up on the cathode and anode surfaces, and increase the amperage loading from 2 mA/sq·cm. to 1 A/sq·cm. The turbulence generates a fine floc that is discharged with a downstream skimmer.

U.S. Pat. No. 4,119,518 is directed to a self cleaning electro-chemical cell that includes a fluidized bed of near spherical particles that scour the surfaces of the cathode and anode. The patent discloses the use of a dimensionally stable anode coating such as platinum and tantalum to generate hypo-chlorous acid, aluminum or iron anodes to create a flocculating agent and a copper or silver anode to generate disinfection metal ions in the treated water. A glass or ceramic spherical particle can be used with the electro-chemical flocculation of waste water. The patent further discloses the use of an ion exchange resin particle that can be used with the fresh water treatment to decrease an ohmic voltage drop in the gap between the electrodes thereby increasing the treatment surface area sued to soften the hard water.

U.S. Pat. No. 6,332,979 discloses a system that includes carbon dioxide gas injection and electro chemical cell treatment for the control of bio-film; corrosion and scale build up on cooling tower heat exchanger surfaces. The pH is maintained between 7.5 and 8.5 with the carbon dioxide gas injection for optimum calcium carbonate scale reduction and bio-film control. U.S. Pat. No. 6,228,249 discloses an electro-chemical cell process to make food grade calcium carbonate from natural sources containing heavy metal contamination. In this patent the electro-chemical cell treatment of the brine precipitates the heavy metals. These precipitates are then removed by filtration. Finally, food grade calcium carbonate is precipitated out of the lime brine by the injection of carbon dioxide gas.

U.S. Pat. No. 5,057,198 discloses a brine softening system that utilizes an electro-chemical cell with a cation exchange membrane separating the anode compartment from the cathode compartment. The cation exchange membrane allows the divalent ions to be transported from the anode compartment to the cathode compartment. The raw brine is introduced into the cathode compartment where the pH is maintained between 10.5 and 11.5 to enhance the precipitation of magnesium hydroxide and the co-adsorption of silicate on magnesium hydroxide precipitate. The brine flow turbulence is used to reduce calcium carbonate scale build up on the cathode surface. The precipitates are filtered from the catholyte and the catholyte is returned to the anode compartment for pH adjustment back to 6-7. The brine Langelier Saturation Index (LSI) should range from −4 to −5. Heating the brine from 10 to 40 degrees C. will decrease the electrical power consumption by 30% and decrease the brine LSI range from −4.5 to −5.5.

U.S. Pat. No. 5,843,291 discloses a system for softening hard water with an electro-chemical cell using a laminar flow of water between the electrodes. The acidic and basic water is collected at the end of the electrode through perforations in the electrode surface. The polarity at the electrode is reversed to remove the calcium carbonate scale buildup on the cathode surface during the cleaning cycle. The polarity reversal will not remove organic gums or iron oxide buildup.

U.S. Pat. No. 3,014,855 discloses how to soften hard water with electro-dialysis. The system includes an electro-chemical cell with both cation and anion exchange membranes. The electrode polarity is reversed to remove the calcium carbonate build up on the cation membrane surface. U.S. Pat. No. 7,329,358 discloses a system that can purify hard water with a continuous electro-deionization for use in the beverage industry. In this disclosure ozone is used to disinfect the water and remove hydrogen sulfide by oxidation to a sulfate and also remove the iron by oxidation to an iron oxide that is subsequently filtered out.

None of the electro-chemical brine softening methods discussed above can be used in an oil field environment because the equipment and methods are unable to handle large fluctuations in temperature, hardness and total dissolved solids (TDS) concentrations, and crude oil, asphaltene, grease, iron and hydrogen sulfide contamination.

The present invention overcomes the shortcomings of the prior systems and methods. It provides an effective and efficient mobile self-cleaning electro-chemical cell that will reduce the LSI of brine in the harsh are difficult environment of oil field development and production.

### SUMMARY OF THE INVENTION

The present invention is directed to a process and apparatus that provides a solution for oil and gas companies that will recycle the produce brine and flow back water at the production well site. The apparatus is skid mounted and contained within a mobile container module that can be easily transported from well site to well site. It includes an electro-chemical cell that is particularly well suited for oil field applications. The cell uses carbon dioxide for pH adjustment to optimize calcium carbonate precipitation. The anode current is adjusted to produce enough hypo-chlorous acid for sterilization of the brine. The calcium carbonate is precipitated on the heated cathode surface and surface is continuously cleaned with ultrasound.

Accordingly, it is an objective of the instant invention to provide a method and apparatus for effectively and efficiently recycling produce brine and flow back water.

It is a further objective of the instant invention to provide effective electro-chemical brine softening apparatus and method without the use of environmentally dangerous and costly materials.

It is yet another objective of the instant invention to provide a method and apparatus for reducing the scaling tendency of fracture treatment flow back water that is self cleaning and is able to sterilize the brine

It is a still further objective of the invention to provide an apparatus that is compact in size and skid mounted so that it is easily moved from site to site within a transportable container.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a top view of the water treatment system mounted on a skid.

FIG. 2 is a sectional top view of the water treatment system.

FIG. 3 is a perspective view of the water treatment system.

FIG. 4 is a side view of the water treatment system.

FIG. 5 is an end view of the water treatment system.

FIG. 6A is a side view of the conduit segment containing a heated cathode and an ultrasonic generator.

FIG. 6B is a perspective view of the conduit segment containing a heated cathode and an ultrasonic generator.

FIG. 6C is a sectional view of the conduit segment containing a heated cathode and an ultrasonic generator.

FIG. 6D is an end view of the conduit segment containing a heated cathode and an ultrasonic generator.

FIG. 7A is a sectional top view of a conduit segment containing a hydro dynamic cavitation device.

FIG. 7B is a sectional side view of a conduit segment containing a hydro dynamic cavitation device.

FIG. 7C is a perspective view of a conduit segment containing a hydro dynamic cavitation device.

FIG. 8 is a schematic representation of the system to treat processed flow back water.

### DETAILED DESCRIPTION OF THE INVENTION

The present invention provides a solution to oil and gas companies for recycling the produce brine and flow back water at the production well site. Filtered, oxidized, and sterilized flow back water or produced water is brought to the new production well site where it is mixed with fresh water to an appropriate total dissolved solids (TDS) concentration for hydration of the fracture treatment polymer system. The blended water is stored in mobile tanks until pumped away with the fracture treatment of the production well.

As the stored water mixture is pumped to a blender, it is treated with an electro-chemical cell and carbon dioxide is injected into the flow. As the carbonated water passes over heated cathode surfaces, the hardness salts are encouraged to precipitate by super-saturation. The precipitated scale is ground up into a colloidal suspension with the ultrasonic field. The blender takes the treated water and hydrates friction reduction polymer as well as mixing with other chemicals. The polymer blend can also be mixed with proppant before it is pumped down the well bore.

The treated water is softened thus the scaling tendency of the calcium carbonate salt is nullified or reduced and the polymer hydration is complete in the brine. In the process of softening hard water, bicarbonate hardness can be reduced by the application of heat at the surface of the heated cathode, encouraging the carbonate salts to precipitate.

Ca²+CO₃²⁻===>CaCO₃₍ₛ₎

2H₂O_{(I)}+2e⁻==>H_{2(g)}+2OH⁻

The deposition of scale is a difficulty encountered when using water containing ions of sparingly soluble salts and is one of the major obstacles hampering the performance of gas and oil wells. Scale precipitation occurs whenever processing conditions lead to creation of super saturation with respect to one or more of the sparingly soluble salts e.g. CaCO₃, CaSO₄, BaSO₄, etc. The customary method for preventing the formation of these scale deposits is the acidification of this water by means of a mineral acid. The injection of CO₂ from an external source helps to reduce the pH of water and prevent scaling by softening water and thus eliminate the use of HCL at the frac job site. The present invention in directed to a skid mounted multi-tube water softening system in which the hard water to be softened is move in one direction through an inlet pipe where the CO₂ is introduced into the flow through a manifold containing a plurality of nozzle jets. The hard water is progressively mixed with micro sized bubble of CO₂ using hydrodynamic and acoustic cavitation in the treatment conduit and undergoes electro-chemical treatment within the system.

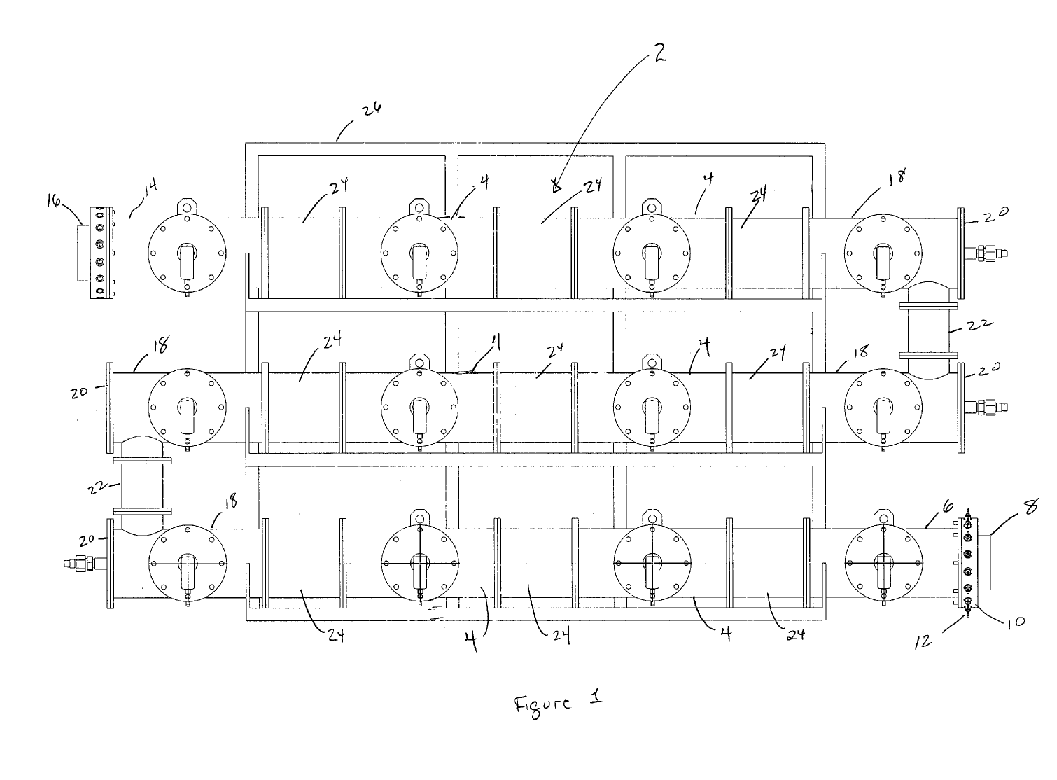

FIG. 1 is a top view of the water treatment system. As shown therein, the system includes a treatment conduit comprised of a plurality of segments that are interconnected in a serpentine fashion. The fluid treatment conduit 2 includes a first group of segments 4 each containing an electrically heated cathode, an ultrasonic transducer and an anode disk, as will be described in more detail below. An additional segment 6 also includes an electrically heated cathode, an ultrasonic transducer, an anode disk, as well as includes an inlet 8 for the fluid treatment conduit 2 and an annular manifold 10 supporting a plurality of injection nozzles 12 located around the circumference of the interior flow passageway. Annular manifold 10 and nozzles 12 are in fluid communication with a source of compressed carbon dioxide gas for introduction into the water to be treated. Likewise segment 14 includes an electrically heated cathode an ultrasonic transducer, an anode disk as well as an outlet 16 for the fluid treatment conduit 2. Segments 18 each contain an end plate 20 and an aperture that is fluidly and mechanically attached to connector conduit members 22. The fluid treat conduit 2 also includes a second group of segments 24. Each segment 24 includes a series of plates that are sized and configured to create hydrodynamic cavitation in the flow thereby enhancing the fluid mixture. The fluid treatment conduit 2 is mounted on a skid 26 that includes side rails and connecting support beams to support the treatment conduit 2 and associated devices.

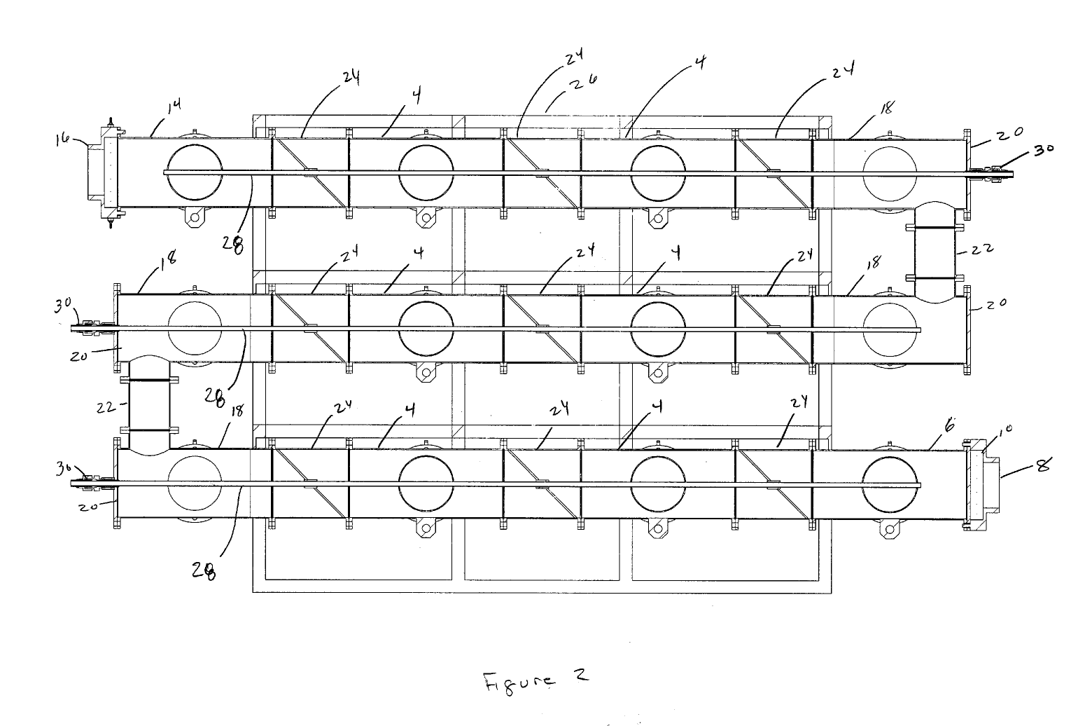

FIG. 2 is a sectional top view of the fluid treatment system shown in FIG. 1 and discussed above. In addition, FIG. 2 illustrates anodes 28 that are configured as elongated rods that are positioned with the fluid treatment conduit 2 and extend through a plurality of segments 4 and a plurality of segments 24. As shown the treatment conduit includes three anode rods 28 however the number of rods and their respective length can be varied as the circumstances warrant. Each rod 28 is individually supported in an end plate 20 and terminates in an electrode 30 that is electrically connected to a power supply to provide electricity to the anode. The anode can be formed from any electrically conductive material. Preferably an aluminum anode is used to encourage flocculation of precipitate.

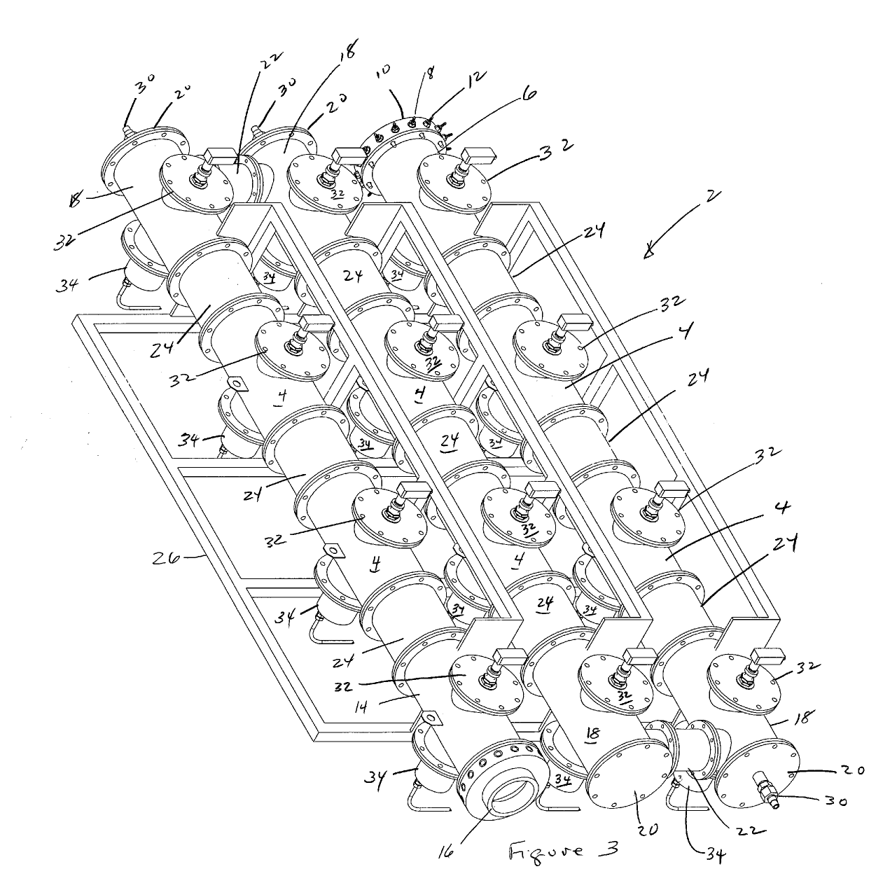

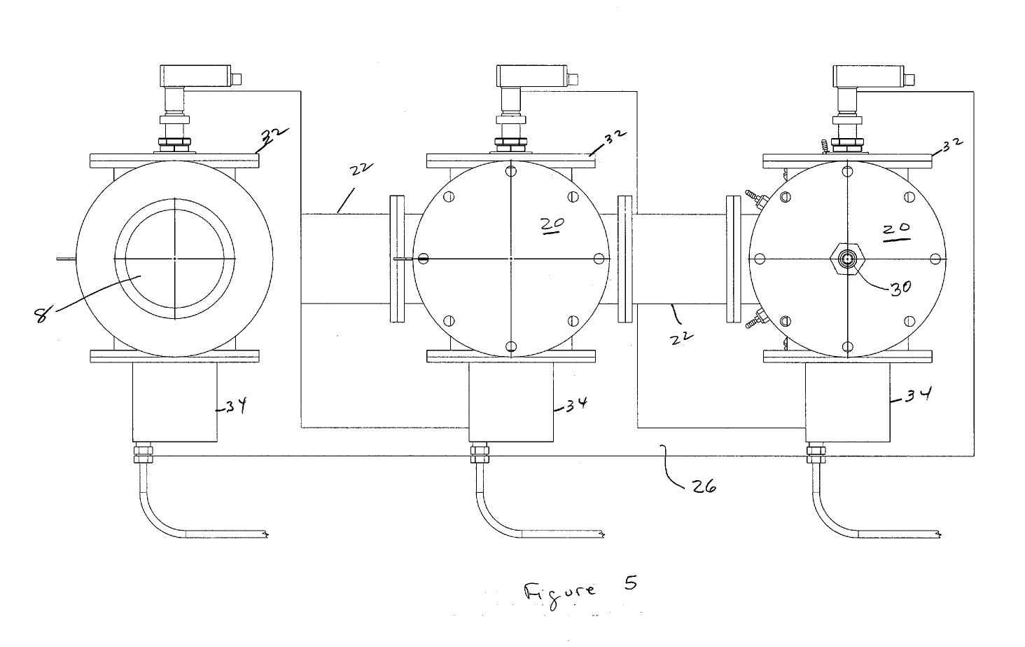

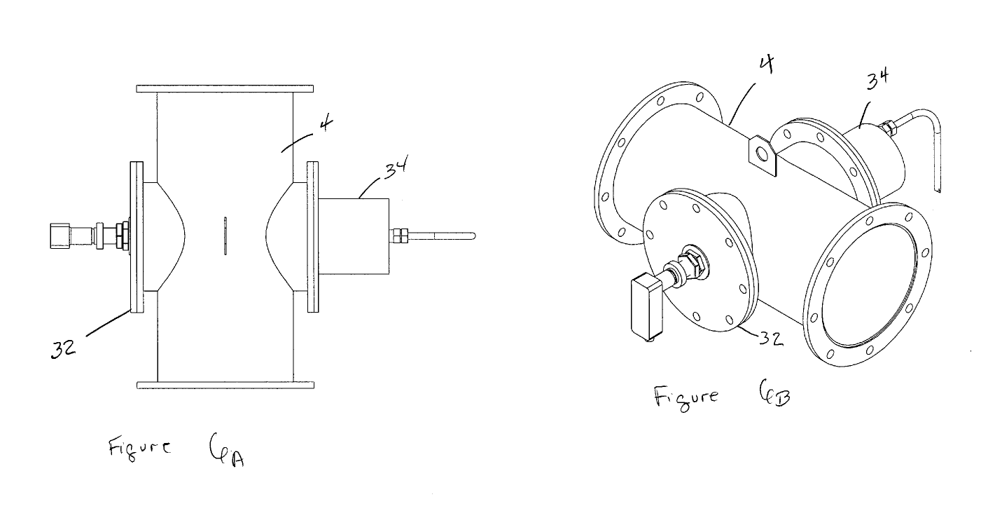

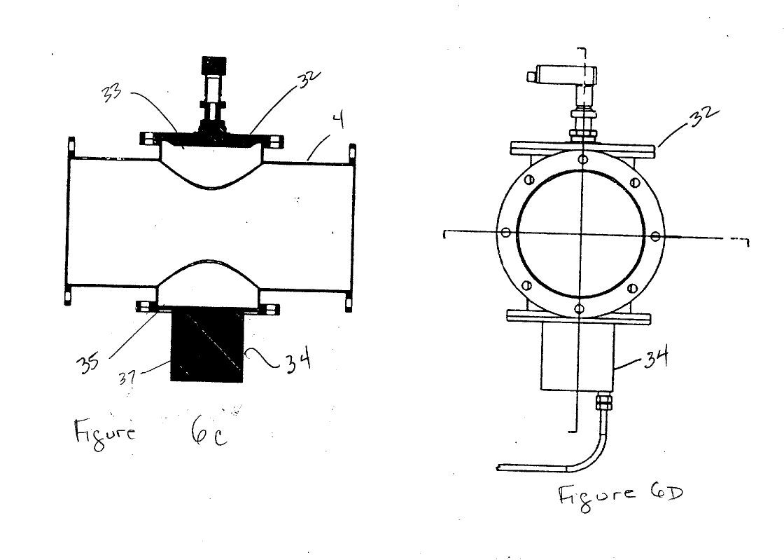

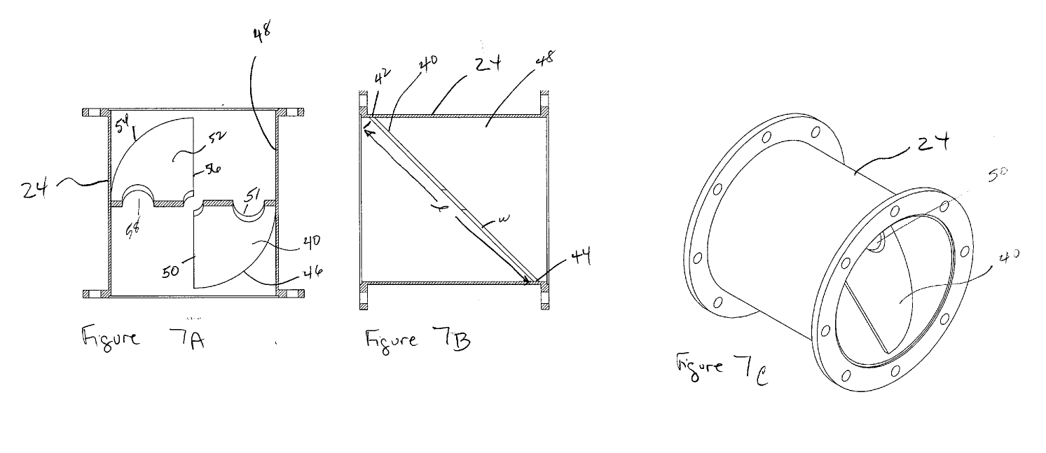

FIG. 3 is a perspective view of the fluid treatment system shown and described in FIGS. 1 and 2. In addition, FIG. 6C illustrates the housings 32 mounted on segments 4 each containing an anode disk 33. Mounted diametrically opposite each housing 32 is a housing 34 containing an ultrasonic transducer 37 with an electrically heated cathode surface 35.

FIG. 4 is a side view of the fluid treatment system shown in FIGS. 1 through 3 showing the first portion of the serpentine path taken by the fluid treatment conduit 2.

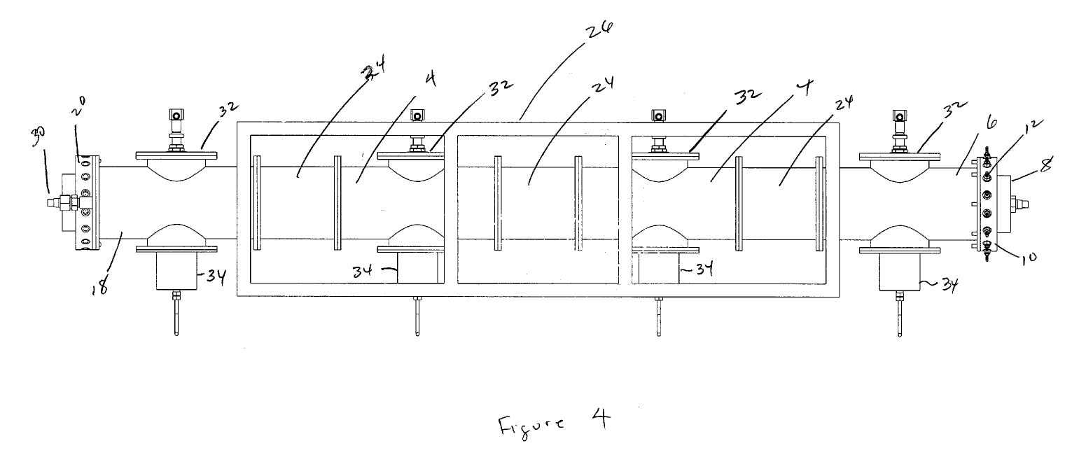

FIG. 5 is an end view of the fluid treatment system shown and described in FIGS. 1 through 4. This end view illustrates inlet 8 end plates 20 and connecting conduit members 22. Also shown are the housings 32 containing the anode disk 33 and housings 34 for the ultrasonic transducer 37 and heated cathode surface 35. One of the end plates 20 includes an electrode 30 that is electrically connected to the anode rod. 28. Also shown is a side view of skid 26.

FIG. 6A is a side view of one of the segments 4 each containing an anode 33 within housing 32 and a heated cathode surface 35 and ultrasonic generator 37 within housing 34. The cathode surface 35 within housing 34 is electrically heated to a point below the below the boiling temperature of brine to super-saturate the hardness salts on the cathode surface and the bicarbonate ion concentration is set to maximize precipitation of hardness ions. As the carbonated water passes over the heated cathode surface 35, the hardness salts are encouraged to precipitate by super-saturation with local temperature increase of 70° F. and a resulting pH increase to around 11. The ultrasonic transducer 37 within the housing 34 is set at a level to grind the precipitate to a size of less than one micron. FIG. 6B is a perspective view of segment 4. As can be seen in this figure the inlet and outlet of segment 4 each include an annular flange with a plurality of apertures therein that are circumferentially spaced form one another. These apertures are configured to be in alignment with adjacent segments such that suitable fastening elements, such as bolts and nuts etc., can be employed to attach the segments to one another in a fluid tight manner. A lifting eye is also attached, by welding for example, to a wall of segment 4. FIG. 6C shows a sectional side view of segment 4 and FIG. 6D shows an end view a segment 4.

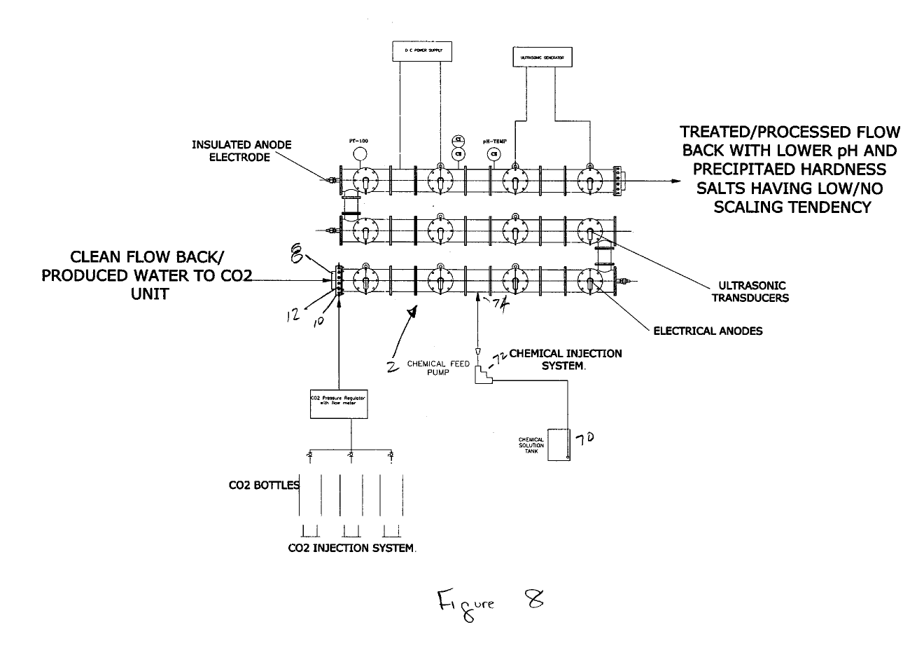

FIG. 7A is a top sectional view of segment 24. FIG. 7B is a sectional side view of segment 24 and FIG. 7C is a perspective view of segment 24. The baffle unit within the segment 24 consists of a first plate 40 and a second plate 52. The first plate 40 is defined by a first end 42 space from a second end 44 by a length (l) which is approximately twice the inner diameter of the segment 24. The first plate 40 has a width (w) which is approximately the same thickness (t) of the cylindrical wall of segment 24. The first plate 40 is further defined by a curved outer edge 46 that is crescent shaped and sized to follow the inner cylindrical wall 48 of the segment 24 and has a straight edge 50 extending from the first end 42 to the second end 44 along the approximate center line of the segment 24. One or more apertures 51 are positioned in the plate in a predetermined size and position calculated to provide optimum cavitation with minimal pressure loss. Low iron content stainless steel, titanium, or certain thermoplastics is suitable for the high flow operation with minimal corrosion of the plate edges.

The second plate 52 forms the mirror image of the first plate 40. The second plate 52 is defined also by a first end spaced from a second end by a length (l) which is approximately twice the inner diameter of the segment 24. The second plate 52 has a width (w) which is also approximately the thickness of the cylindrical wall of segment 24. The second plate 52 is further defined by a curved outer edge 54 sized to follow the inner cylindrical wall 48 of segment 24 and also has a straight edge 56 extending from the first end to the second end along the Approximate center line of the segment 24. The second plate 52 has one or more apertures 58 that are positioned in the plate in a predetermined size and position calculated to provide optimum cavitaion with minimal pressure loss. The apertures 51 and 58 are flow thru and each includes a fluid orifice formed by the use of sharp edges so that each aperture is formed perpendicular to the plate and thus positioned at an angle to the fluid flow to create a constriction area. The cross-sectional profile design creates the flow constriction are along the edges 50 and 56 and edges to apertures 51 and 58. The shape edges on the exit side of each edge from vena contract eddys and fluid shearing. A high fluid flow velocity provides for a hydrodynamic cavitaion filed downstream of each baffle unit. The flow velocity in a local constriction is increased while the pressure is decreased, with the result that the cavitaion voids are formed in the fluid flow past the baffle unit to form cavitaion bubbles which create the cavitaion filed. The cavitation bubbles enter into the increased pressure zone resulting from a reduced flow velocity, and collapse. The resulting cavitation exerts a physico-chemical effect on the liquid.

Each aperture is sized to a plate and requires a diameter to match the length, width, and thickness of the plate, all of which are constructed and arranged to induce hydrodynamic cavitaion by implosion if the cavitation induced increase pressure zone where coordinated collapsing occurs. The implosion is accompanied by high local pressure (up to 1500 MPa) and temperature (up to 15,000 degrees K.) as well as by other physico-chemical which initiate the progress of chemical reactions in the fluid that can change the composition of the mixture. Cavitation bubbles generally contain gases and vapors. Collapsing the cavitation bubbles may produce localized high energy conditions like high pressures, high temperatures requiring the baffles to be formed from a corrosive resistant material. When gases are present, high temperatures may occur when the cavitation bubbles collapse and plasmas may be created. The plasmas may emit ultraviolet light to be emitted in pulses. Emission of this ultraviolet light may be called cavitation luminescence. The ultraviolet light may irradiate oxidizing agents contained within and/or associated with the cavitation bubbles. Irradiating oxidizing agents may produce ionization of the oxidizing agents. Irradiating oxidizing agents may produce hydroxyl radicals. The hydroxyl radicals may contact and/or react with organic compounds in a fluid or solution in which the cavitation bubbles are produced. These reactions may destroy or degrade the organic compounds, through the breakage of chemical bonds with the compounds, for example. These reactions may produce partial oxidation of the organic compounds. These reactions may also produce complete oxidation of the organic compounds, to carbon dioxide and water, for example. The fluid or solution that has been treated by the cavitation based method may be called a product of the method.

FIG. 8 is a schematic representations of the system used to treat processed flow back water. As illustrated, clean flow back water or produced water is introduced into the inlet 8 of treatment conduit 2. Carbon dioxide gas is introduced into the flow of water through nozzle jets 12 which are fed through annular manifold 10 that is fed by pressurized carbon dioxide bottles. The supply of carbon dioxide is metered by a variable pressure regulator. The hard water is progressively mixed with micro sized bubbles of carbon dioxide using hydrodynamic and acoustic cavitation in the treatment conduit. As the carbon dioxide injection is increased it is possible to drop the final pH to 6. Segment 4 in the treatment conduit 2 contains a disc anode 33 within housing 32 and a housing 34 containing an ultrasonic transducer 37 and a heated cathode surface 35. The disc anode releases DC current in the water. The ultrasonic transducer 37 opposing the disc anode creates the acoustic cavitation making the carbon dioxide bubbles collapse thus increasing the mass transfer efficiency. The ultrasonic transducer is also used to self-clean the cathode surface of hardness salts. The baffle unit, or static mixer, in segment 24 creates hydrodynamic cavitation thereby facilitating the increased mixing of carbon dioxide and higher mass transfer efficiency. As the carbonated water passes over the heated cathode surface 35, hardness salts are encouraged to precipitate by super-saturation with local temperature increase of 70 degree F. and a pH increase to around 11. Ozone may be co-injected with the carbon dioxide to thereby sterilize the brine and oxidize metal such as iron to iron oxide and convert dissolved organics to carbon dioxide. A chemical supply tank 70 and chemical feed pump 72 can be utilized to inject additional chemicals into the flow via inlet 74. For example, sodium carbonate or sodium sulfate can be added to maximize hardness precipitation. Additionally, sulfated fatty acids such as SDS can be added to catalyze seed crystal formation of calcium carbonate and sulfate. Sodium lauryl sulfate or sodium laurate surfactant can be used as a setting agent for the carbon dioxide gas and as a seed crystal generator for precipitation. Necessary power supplies and instrumentation will be provided as shown in FIG. 8.

The treatment process will precipitate hardness salts and reduce scaling tendencies. The treated brine should have a Langelier Saturation Index (LSI) ranging from −1 to −3.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An apparatus for treating processed flow back water comprising;
a fluid treatment conduit having an inlet and an outlet, said fluid conduit comprised of a plurality of treatment segments;
a source of carbon dioxide gas and a plurality of carbon dioxide gas inlets communicating with at least one of said treatment segments;
an anode and cathode located within at least one of said treatment segments;
an ultrasonic transducer located in at least one of said treatment segments; and
a static mixing device located in at least one of said treatment segments;
whereby the processed flow water at said outlet has a lower pH and precipitated hardness salts than said inlet thereby reducing the scaling tendency of the flow back water.

2. The apparatus for treating processed flow back water of claim 1, further wherein said fluid treatment conduit includes at least one connecting segment that connects two treatment segments.

3. The apparatus for treating processed flow back water of claim 2, wherein there are at least two connecting segments.

4. The apparatus for treating processed flow back water of claim 2 wherein said fluid treatment conduit is mounted on a skid whereby the fluid conduit can be moved as a module.

5. The apparatus for treating processed flow back water of claim 1, wherein said source of carbon dioxide includes one or more pressurized bottles and said plurality of carbon dioxide gas inlets are formed as injection nozzles located in an annular manifold within at least one of said treatment segments.

6. The apparatus for treating processed flow back water of claim 5 wherein said annular manifold in located adjacent said fluid treatment conduit inlet.

7. The apparatus for treating processed flow back water of claim 1 wherein said anode is in the form of a rod that extends through a plurality of treatment segments.

8. The apparatus for treating processed flow back water of claim 1 wherein said cathode is mounted in one or more of said plurality of treatment segments.

9. The apparatus for treating processed flow back water of claim 1 wherein said ultrasonic transducer is mounted in one or more of a first group said plurality of treatment segments.

10. The apparatus for treating processed flow back water of claim 8 wherein said static mixing device is mounted in one or more of a second group of said plurality of treatment segments.

11. The apparatus for treating processed flow back water of claim 10 wherein at least one of said first group of said treatments sections is adjacent and directly connected to at least one of said second group of treatment sections.

12. The apparatus for treating processed flow back water of claim 10 wherein said static mixing device includes a pair of plates, each plate having at least one aperture, thereby creating hydrodynamic cavitation within the treatment segment.

13. The apparatus for treating processed flow back water of claim 9 wherein the cathode is mounted in one or more of said first group of said plurality of treatment segments.

14. The apparatus for treating processed flow back water of claim 13 wherein the cathode has a heated surface.

15. The apparatus for treating processed flow back water of claim 14 wherein said cathode and heated surface is mounted adjacent said ultrasonic transducer.

16. The apparatus for treating processed flow back water of claim 13 further including an anode disk mounted within one or more of said first group of said plurality of treatment segments in opposed relationship to said cathode.

17. The apparatus for treating processed flow back water of claim 1 further including an inlet port for injection of supplemental chemical additive.

18. The apparatus for treating processed flow back water of claim 4 wherein said skid is removably mounted on the bed of a truck trailer.

19. The apparatus for treating processed flow back water of claim 4 wherein said skid further includes a dc power supply and an ultrasonic generator.

20. The apparatus for treating processed flow back water of claim 9 wherein some of the first group of treatment segments includes an end plate.

21. The apparatus for treating processed flow back water of claim 20 further including an insulated electrode mounted on the end plate that is electrically connected to the anode, said anode in the form of a rod that extends through a plurality of treatment segments.

22. The apparatus for treating processed flow back water of claim 9 further wherein said fluid conduit includes at least one connecting segment that connects a pair of first group treatment segments.

23. The method of treating flow back water at a frac site comprising the steps of:
conducting flow back water into the inlet of a fluid treatment conduit;
admitting carbon dioxide into the fluid treatment conduit to mix with the flow back water;
introducing DC current into the flow back water within the fluid treatment conduit; mixing the flow back water with said carbon dioxide using hydrodynamic and acoustic cavitaion within said fluid treatment conduit; and
discharging the treated flow back water through an outlet of the fluid treatment conduit,
whereby the admission of carbon dioxide will reduce the pH of the flow back water and prevent scaling by softening the water and thus eliminating the use of HCL at said frac site.

24. The method of treating flow back water at a frac site as set forth in claim 23 further comprising the steps of regulating the amount of carbon dioxide admitted into the fluid treatment conduit.

25. The method of treating flow back water at a frac site as set forth in claim 23 further comprising the steps of admitting ozone with the carbon dioxide whereby the ozone sterilizes the brine and oxidizes the metals such as iron to iron oxide and dissolved organics to carbon dioxide.

26. The method of treating flow back water at a frac site as set forth in claim 23 further including the step of adding sodium sulfate to the flow back water to maximize hardness precipitation.

27. The method of treating flow back water at a frac site as set forth in claim 23 further including the step of adding sodium carbonate to the flow back water to maximize hardness precipitation.

28. The method of treating flow back water at a frac site as set forth in claim 23 further including the step of adding sulfated fatty acids to the flow back water to catalyze seed crystal formation of calcium carbonate and sulfate.

29. The method of treating flow back water at a frac site as set forth in claim 23 further including the step of mounting said fluid treatment conduit on a skid whereby said fluid treatment conduit is easily transportable as a unit.
